(19) United States
(12) Patent Application Publication
(10) Pub. No.: US 2026/0003074 A1
(43) Pub. Date: Jan. 1, 2026

(54) TIME TO ANGLE SORTING CAMERA

(71) Applicant: ARIZONA BOARD OF REGENTS ON BEHALF OF THE UNIVERSITY OF ARIZONA, Tucson, AZ (US)

(72) Inventor: Yuzuru Takashima, Tucson, AZ (US)

(73) Assignee: ARIZONA BOARD OF REGENTS ON BEHALF OF THE UNIVERSITY OF ARIZONA, Tucson, AZ (US)

(21) Appl. No.: 19/116,919

(22) PCT Filed: Sep. 28, 2023
(86) PCT No.: PCT/US2023/075403

§ 371 Date: Mar. 28, 2025

Related U.S. Application Data
(60) Provisional application No. 63/410,785, filed on Sep. 28, 2022.

(51) Int. Cl. G01S 17/88; G01S 7/481; G01S 7/497; G01S 17/46; G01S 17/86

(52) U.S. Cl. CPC G01S 17/88; G01S 7/4816; G01S 7/4972; G01S 17/46; G01S 2007/4975; G01S 17/86

(57) ABSTRACT

A time to angle camera sorting system that uses a short pulsed laser, a lens, an array of DMDs, a camera, and a processor. As the laser illuminates the space before it, DMDs turn on and off between their tilt angles, and diffracted light is returned and captured. The light data is sent to the processors which are programmed, configured, or structured to map the time of arrival of the light data with the angle data of the DMDs associated with each light data point, and then process an image based on the mapped time to angle mapped data.

### CROSS-REFERENCE TO RELATED APPLICATION

The present application relates and claims priority to U.S. Provisional Patent Application No. 63/410,785, filed Sep. 28, 2022, the entirety of which is hereby incorporated by reference.

### GOVERNMENT FUNDING

N/A

### FIELD OF THE INVENTION

The present disclosure is directed generally to camera-based object recognition useful in autonomous travel applications.

### BACKGROUND

Camera based object recognition and autonomous driving based on the information (i.e., location, type, velocity of objects) is one of the critical functions for Advanced Driver Assistant System for automotives (FIG. 1a). Camera-based ADAS is not only applicable for ground-based mobility (i.e., vehicles, taxies, and convoy of tracks) but also is for mobility in air too. Recently, Amazon announced “Amazon Prime Air”. An FAA approved delivery drones carry packages while drones are autonomously navigated by camera (FIG. 1b). Another example is “Flying taxi” by an electric vertical take-off and landing (eVTOL) aircraft (FIG. 1c). The eVTOL is equipped with an electric motor thruster and flies at 150-300 m above the ground.

All such mobility infrastructures rely upon situation awareness (SA) by camera, and other means such as radar and Lidar (Light detection and ranging). One of the common challenges in situation awareness for urban mobility as an infrastructure is robustness to weather conditions, for example, fog, rain, and snow. The camera-based SA does not work well in such conditions. In contrast, the radar, i.e., at 94 GHz can see through fog since the wavelength is much longer compared to the length scale of fog and rainwater particles. However, known challenges are resolution and signal contrast. In particular for ADAS for ground-based transportations, the longer wavelength of radar prohibits detection of small objects (such as pedestrians and bicycles). While radar can be a promising SA modality for ADAS in ground and in air under relatively less dense traffic, camera-based SA is still the best option in dense traffic especially for the good weather situation, and performance enhancement of the camera in bad weather benefits both on-ground and in-air mobility.

Recently, applying the principle of the time-of-flight lidar to camera-based SA has gathered attention. Lidar employs a short pulse illumination of objects and measures roundtrip time of the short pulse of the returning signal. In foggy and/or rainy conditions, the water droplets generate echo signals that obscures the signal of interest.

Accordingly, there is a need in the art to discriminate the echo of the fog from the signal of the object in the time domain. For example, consider a short laser pulse propagating though the fog and illuminating the object. While the short pulse interacts with the water droplet multiple times, the pulse length of the echo signal becomes much longer than the signal from the object. With use of a camera with a very high frame rate, each of the frames contains such information of fog and object that is postprocessed to reveal the object behind the fog.

There is also a need in the art for a fusion of lidar and camera technology to complement radar. The challenge is how to achieve time and space domain engineering to capture an image through fog/rain with existing camera systems but without employing cost and time prohibitive scientific solutions, such as highly expensive streak cameras that typically cost around $100,000.

### SUMMARY

The present disclosure is directed to a time to angle camera sorting system.

According to an aspect, a vision system is provided and comprises a laser oriented to direct a series of pulses of light in a predetermined direction; a lens having a focal plane positioned to receive a return signal from an object, from any of a first series of water droplets that may be positioned between the laser and the object, and from any of a second series of water droplets that may be positioned on an opposing side of the object from the laser; a digital micromirror device having a plurality of micromirrors positioned behind the lens that will switch each micromirror from an on-state through a transitional period to an off-state so that the return signal is sequentially diffracted into a first diffraction order representing a first portion of the return signal reflected by the first series of water droplets, a second diffraction order representing a second portion of the return signal reflected by the object, and a third diffraction order representing a third portion of the return signal reflect by the second series of water droplets; an array of optical imagers positioned to capture a series of images over time of each of the first diffraction order, the second diffraction order, and the third diffraction order; and a processor programmed, structured, and/or configured to map a time of arrival of each the series of images to the first diffraction order, the second diffraction order, and the third diffraction order to separate the second portion of the return signal from the first portion of the return signal and the third portion of the return signal.

According to an embodiment, the laser has a frequency of 405 nanometer.

According to an embodiment, the plurality of micromirrors have a tilt angle of +/−12 degrees between the on-state and the off-state.

According to an embodiment, the array of optical images comprises three optical imagers.

According to an embodiment, the first diffraction order is the −1st order.

According to an embodiment, the first diffraction order is the 0th order.

According to an embodiment, the first diffraction order is the +1st order.

According to an embodiment, each optical imager in the array of optical imagers has a frame rate of thirty milliseconds.

According to an aspect, a method of imaging an object that may be obscured by water droplets is provided and comprises the steps of directing a series of pulses of light from a laser in a predetermined direction; receiving a return signal from an object, from any of a first series of water droplets that may be positioned between the laser and the object, and from any of a second series of water droplets that may be positioned on an opposing side of the object from the laser; sequentially diffracting the return signal with a digital micromirror device having a plurality of micromirrors by switching each micromirror from an on-state through a transitional period to an off-state into a first diffraction order representing a first portion of the return signal reflected by the first series of water droplets, a second diffraction order representing a second portion of the return signal reflected by the object, and a third diffraction order representing a third portion of the return signal reflect by the second series of water droplets; capturing a series of images over time of each of the first diffraction order, the second diffraction order, and the third diffraction order; and mapping a time of arrival of each of the series of images to the first diffraction order, the second diffraction order, and the third diffraction order to separate the second portion of the return signal from the first portion of the return signal and the third portion of the return signal.

According to an embodiment, the laser has a frequency of 405 nanometer.

According to an embodiment, the plurality of micromirrors have a tilt angle of +/−12 degrees between the on-state and the off-state.

According to an embodiment, the array of optical images comprises three optical imagers.

According to an embodiment, the first diffraction order is the −1st order.

According to an embodiment, the first diffraction order is the 0th order.

According to an embodiment, the first diffraction order is the +1st order.

According to an aspect, a testing system for replicating outdoor object detection in ambient weather conditions is provided, comprising a first laser oriented to direct a first series of pulses of light into a first chamber having a first series of water droplets; a second laser oriented to direct a second series of pulses of light into a second chamber containing an object; a third laser oriented to direct a third series of pulses of light into a third chamber having a first series of water droplets; wherein the second series of pulses are delayed by a predetermined amount relative to the first series of pulses; and wherein the third series of pulses are delayed by the predetermined amount relative to the second series of pulses.

According to an embodiment, the predetermined amount is selected to replicate a distance between a vehicle and the object when driving.

According to an embodiment, the testing system further comprises a digital micromirror device having a plurality of micromirrors positioned to receive a combined return signal formed by a first return signal from the first chamber, a second return signal from the second chamber, and a third return signal from the third chamber and to switch each micromirror from an on-state through a transitional period to an off-state to form a first diffraction order representing a first portion of the combined return signal reflected by the first series of water droplets, a second diffraction order representing a second portion of the return signal reflected by the object, and a third diffraction order representing a third portion of the return signal reflect by the second series of water droplets.

According to an embodiment, the testing system further comprises an array of optical imagers positioned to capture a series of images over time of each of the first diffraction order, the second diffraction order, and the third diffraction order.

According to an embodiment, the testing system further comprises a processor programmed, structured and/or configured to map a time of arrival of each the series of images to the first diffraction order, the second diffraction order, and the third diffraction order to separate the second portion of the return signal from the first portion of the return signal and the third portion of the return signal.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIGS. 1(a)-1(c) are images of autonomous driving systems.

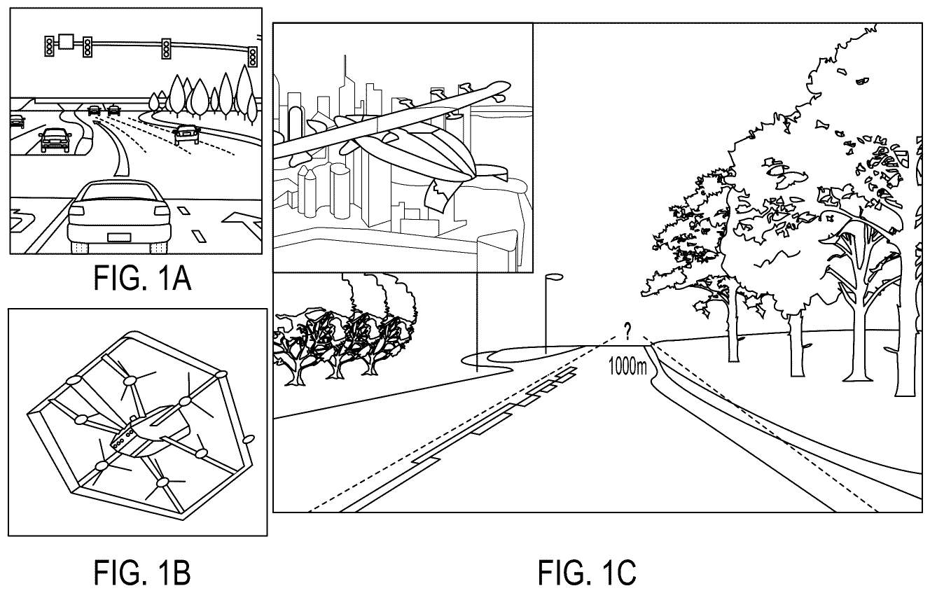

FIGS. 2(a)-(c) are schematic representations of conventional imaging, a time to angle sorting system in accordance with an embodiment, and a slow equivalent light fog chamber system, respectively in accordance with an embodiment.

FIG. 3 is a flow chart showing the steps associated with a method of imaging an object that may be obscured by water droplets, in accordance with an embodiment.

### DETAILED DESCRIPTION OF EMBODIMENTS

The present disclosure describes Time-angular domain processing of image by MEMS device.

“Unveiling the fog” requires “time stamped” images with short interval of, i.e., 5 ns. The frame rate of the conventional camera system is 30 ms. The question is how to fill the gap of the 10⁶ differences (ns vs. ms). The present invention leverages commercially available Micro Electromechanical System (MEMS) device to angularly sort the time sequential images, and capture time stamped image by multiple camera.

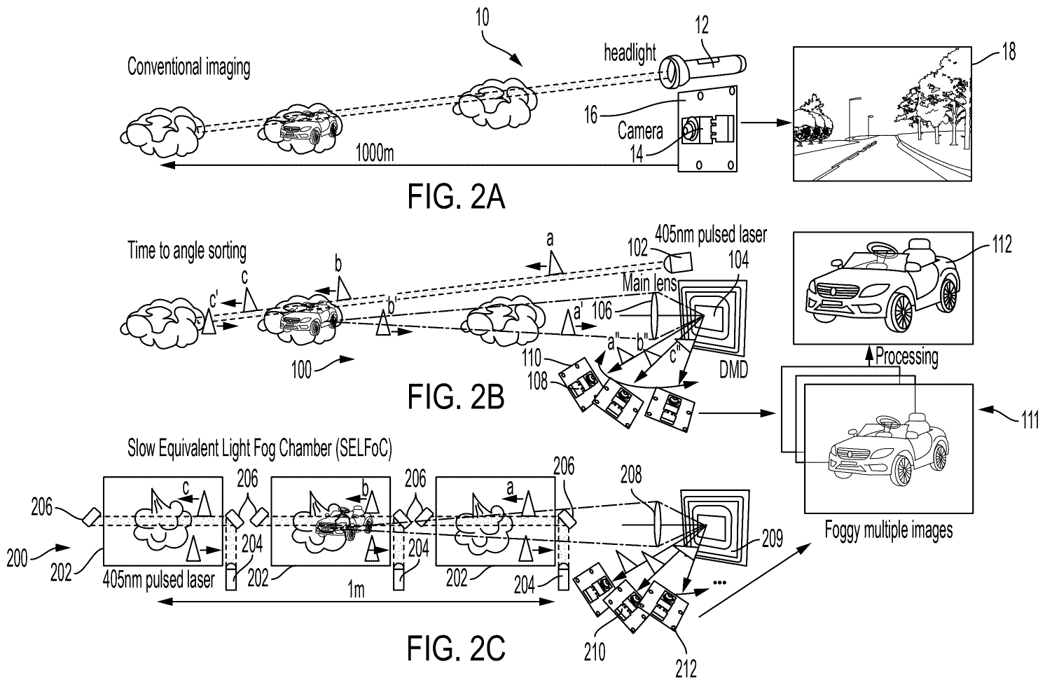

In FIG. 2a, conventional imaging 10 through fog is depicted, with a headlight 12 as a light source and camera module 14 that includes an on-board processor 16 to process the image data and generate an image 18 of the forward scene, which, due to the inability of the optical system, generally des not provide a clear image of any obstacles in the light path.

FIG. 2b shows a MEMS-based time slicing camera system 100 in accordance with an embodiment. The head light 12 is replaced with a laser 102, which in the preferred form is a 405 nm short pulsed laser. A MEMS Digital Micromirror Device (DMD) 104 is placed at the focal plane of a main lens 106. DMD 104 is a binary display device, consisting of millions of micromirrors that turn between on- and off-states in their tilt angles (±12 degrees). While refreshing displayed images by tilting micromirror in ±12 degrees, there is a transitional period within which mirror changes its angle from −12 to +12 degrees. In the transitional period, the returning signal is sequentially diffracted into different diffraction orders, such as the signal from fog between the camera and object (returning pulse “a′”) is diffracted to −1st order, whereas the signal from the object is diffracted to Oth order as returning signal “b′”. The retuning signal “c′” is the latest arriving signal from the farthest object, fog behind the object. Those angular separated images 111 are captured by array of camera modules 108. In this way, the arriving time of images is mapped to diffraction angles to be post processed by a computer/processor 110 (shown as configured on printed circuit board with the camera modules) to unveil the image 112 present in the fog. The computer/processor 110 would be programmed/configured/structured with instructions stored in any known non-transitory computer-readable medium to process the image data.

Since 1000 m imaging is not feasible in lab, applicant structured a “Slow Equivalent Light” Fog Chamber (SELFoC) 200 as depicted in FIG. 2c. The SELFoC 200 mimics the light propagation over the 1000 m distance within 1 m in lab environment by delaying 405 nm light pulses for 20 ns between adjacent SELFoC chambers 202 through use of independent lasers 204 and mirrors 206 which will illuminate the object to be imaged with the light reflecting back through the lens 208 and captured by the DMD 209 (same as DMD 104) and cameras 210 (same as cameras 108) for further processing by a computer/processer 212 (same as processor 110 and configured on-board with the cameras 210). Processing the multiple images 111 will render a clear image 112, as with system 100.

In essence, the SLEFoC testing system 200 replicates outdoor object detection in ambient weather conditions, and comprises a first laser 204 oriented to direct a first series of pulses of light into a first chamber 202 having a first series of water droplets; a second laser 204 oriented to direct a second series of pulses of light into a second chamber 202 containing an object; a third laser 204 oriented to direct a third series of pulses of light into a third chamber 202 having a first series of water droplets. The second series of pulses are delayed by a predetermined amount relative to the first series of pulses, and the third series of pulses are delayed by the predetermined amount relative to the second series of pulses. The predetermined amount is selected to replicate a distance between a vehicle and the object when driving.

The system 200 further comprises a digital micromirror device 209 having a plurality of micromirrors positioned to receive a combined return signal formed by a first return signal from the first chamber 202, a second return signal from the second chamber 202, and a third return signal from the third chamber 202 and to switch each micromirror from an on-state through a transitional period to an off-state to form a first diffraction order representing a first portion of the combined return signal reflected by the first series of water droplets, a second diffraction order representing a second portion of the return signal reflected by the object, and a third diffraction order representing a third portion of the return signal reflect by the second series of water droplets.

The system 200 further comprises an array of optical imagers 210 positioned to capture a series of images over time of each of the first diffraction order, the second diffraction order, and the third diffraction order, and a processor 212 programmed, configured or structured to map a time of arrival of each the series of images to the first diffraction order, the second diffraction order, and the third diffraction order to separate the second portion of the return signal from the first portion of the return signal and the third portion of the return signal.

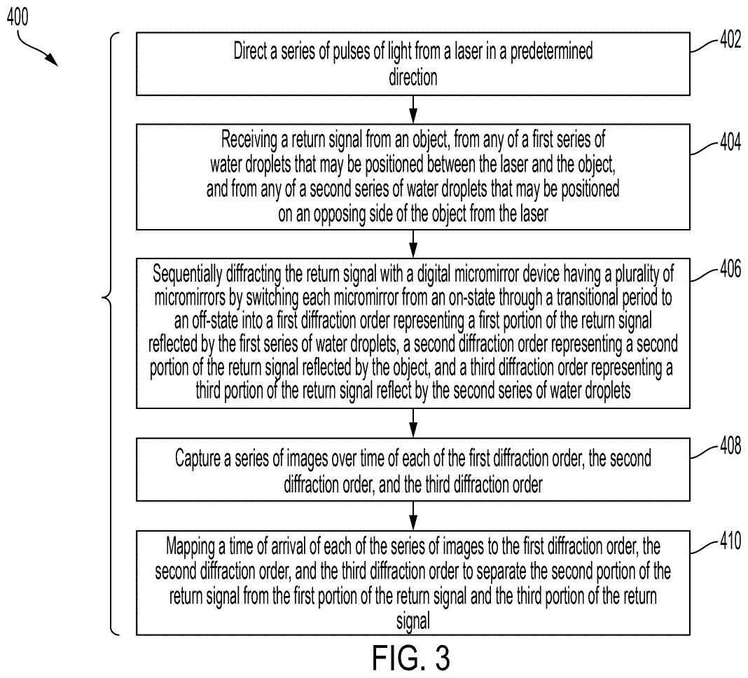

Referring to FIG. 3, the steps associated with a method 400 of imaging an object that may be obscured by water droplets. The steps comprise directing a series of pulses of light from a laser in a predetermined direction 402. Next, the method comprises receiving a return signal from an object, from any of a first series of water droplets that may be positioned between the laser and the object, and from any of a second series of water droplets that may be positioned on an opposing side of the object from the laser 404. Next, the method comprises sequentially diffracting the return signal with a digital micromirror device having a plurality of micromirrors by switching each micromirror from an on-state through a transitional period to an off-state into a first diffraction order representing a first portion of the return signal reflected by the first series of water droplets, a second diffraction order representing a second portion of the return signal reflected by the object, and a third diffraction order representing a third portion of the return signal reflect by the second series of water droplets 406. Next, the method comprises capturing a series of images over time of each of the first diffraction order, the second diffraction order, and the third diffraction order 408. The method further comprises the step of mapping a time of arrival of each of the series of images to the first diffraction order, the second diffraction order, and the third diffraction order to separate the second portion of the return signal from the first portion of the return signal and the third portion of the return signal 410.

The following references are incorporated herein by reference:
Amazon to start delivering packages by drone in Texas later this year (cnbc.com)
Boeing: Autonomous Flying Taxi: EVTOL Unmanned Solar Aircraft System
Satat, Guy, Barmak Heshmat, Dan Raviv, and Ramesh Raskar. “All Photons Imaging Through Volumetric Scattering.” Scientific Reports 6.1 (2016): 33946. Web.
https://www.hamamatsu.com/us/en/product/photometry-systems/streak-camera.html
U.S. patent application Ser. No. 16/604,860, filed Oct. 11, 2019.
Braden Smith, Brandon Hellman, Adley Gin, Alonzo Espinoza and Yuzuru Takashima, “Single Chip Lidar with Discrete Beam Steering by Digital Micromirror Device”, Optics Express, Vol. 25, Issue 13, pp. 14732-14745 (2017) https://doi.org/10.1364/OE.25.014732, https://opg.optica.org/oe/fulltext.cfm?uri=oe-25-13-14732&id=368161
Mukherjee, Saswata, A. Vijayakumar, and Joseph Rosen. “Spatial Light Modulator Aided Noninvasive Imaging through Scattering Layers.” Scientific Reports 9.1 (2019): 17670-11. Web.
B. Hellman, E. Bosset, L. Ender, N. Jafari1, P. McCann, C. Nguyen, C. Summitt, S. Wang, Y. Takashima. “3D Visualization of Optical Ray Aberration and Its Broadcasting to Smartphones by Ray Aberration Generator”, IODC-2017-IM3A.5, International Optical Design Conference 2017 (https://www.osapublishing.org/abstract.cfm?uri=IODC-2017-IM3A.5).

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

What is claimed is:

1. A vision system, comprising:
a laser oriented to direct a series of pulses of light in a predetermined direction;
a lens having a focal plane positioned to receive a return signal from an object, from any of a first series of water droplets that may be positioned between the laser and the object, and from any of a second series of water droplets that may be positioned on an opposing side of the object from the laser;
a digital micromirror device having a plurality of micromirrors positioned behind the lens that will switch each micromirror from an on-state through a transitional period to an off-state so that the return signal is sequentially diffracted into a first diffraction order representing a first portion of the return signal reflected by the first series of water droplets, a second diffraction order representing a second portion of the return signal reflected by the object, and a third diffraction order representing a third portion of the return signal reflect by the second series of water droplets;
an array of optical imagers positioned to capture a series of images over time of each of the first diffraction order, the second diffraction order, and the third diffraction order; and
a processor programmed, configured or structred to map a time of arrival of each the series of images to the first diffraction order, the second diffraction order, and the third diffraction order to separate the second portion of the return signal from the first portion of the return signal and the third portion of the return signal.

2. The system of claim 1, wherein the laser has a frequency of 405 nanometer.

3. The system of claim 2, wherein the plurality of micromirrors have a tilt angle of +/−12 degrees between the on-state and the off-state.

4. The system of claim 3, wherein the array of optical images comprises three optical imagers.

5. The system of claim 4, wherein the first diffraction order is the −1st order.

6. The system of claim 5, wherein the first diffraction order is the 0th order.

7. The system of claim 6, wherein the first diffraction order is the +1st order.

8. The system of claim 7, wherein each optical imager in the array of optical imagers has a frame rate of thirty milliseconds.

9. A method of imaging an object that may be obscured by water droplets, comprising the steps of:
directing a series of pulses of light from a laser in a predetermined direction;
receiving a return signal from an object, from any of a first series of water droplets that may be positioned between the laser and the object, and from any of a second series of water droplets that may be positioned on an opposing side of the object from the laser;
sequentially diffracting the return signal with a digital micromirror device having a plurality of micromirrors by switching each micromirror from an on-state through a transitional period to an off-state into a first diffraction order representing a first portion of the return signal reflected by the first series of water droplets, a second diffraction order representing a second portion of the return signal reflected by the object, and a third diffraction order representing a third portion of the return signal reflect by the second series of water droplets;
capture a series of images over time of each of the first diffraction order, the second diffraction order, and the third diffraction order; and
mapping a time of arrival of each of the series of images to the first diffraction order, the second diffraction order, and the third diffraction order to separate the second portion of the return signal from the first portion of the return signal and the third portion of the return signal.

10. The method of claim 8, wherein the laser has a frequency of 405 nanometer.

11. The method of claim 9, wherein the plurality of micromirrors have a tilt angle of +/−12 degrees between the on-state and the off-state.

12. The method of claim 10, wherein the array of optical images comprises three optical imagers.

13. The method of claim 11, wherein the first diffraction order is the −1st order.

14. The method of claim 12, wherein the first diffraction order is the 0th order.

15. The method of claim 13, wherein the first diffraction order is the +1st order.

16. A testing system for replicating outdoor object detection in ambient weather conditions, comprising:
a first laser oriented to direct a first series of pulses of light into a first chamber having a first series of water droplets;
a second laser oriented to direct a second series of pulses of light into a second chamber containing an object;
a third laser oriented to direct a third series of pulses of light into a third chamber having a first series of water droplets;
wherein the second series of pulses are delayed by a predetermined amount relative to the first series of pulses; and
wherein the third series of pulses are delayed by the predetermined amount relative to the second series of pulses.

17. The system of claim 16, wherein the predetermined amount is selected to replicate a distance between a vehicle and the object when driving.

18. The system of claim 17, further comprising a digital micromirror device having a plurality of micromirrors positioned to receive a combined return signal formed by a first return signal from the first chamber, a second return signal from the second chamber, and a third return signal from the third chamber and to switch each micromirror from an on-state through a transitional period to an off-state to form a first diffraction order representing a first portion of the combined return signal reflected by the first series of water droplets, a second diffraction order representing a second portion of the return signal reflected by the object, and a third diffraction order representing a third portion of the return signal reflect by the second series of water droplets.

19. The system of claim 18, further comprising an array of optical imagers positioned to capture a series of images over time of each of the first diffraction order, the second diffraction order, and the third diffraction order.

20. The system of claim 19, further comprising a processor programmed to map a time of arrival of each the series of images to the first diffraction order, the second diffraction order, and the third diffraction order to separate the second portion of the return signal from the first portion of the return signal and the third portion of the return signal.
